(19) United States
(12) Patent Application Publication
(10) Pub. No.: US 2003/0102613 A1
(43) Pub. Date: Jun. 5, 2003

(54) Elevator noise and vibration isolation system

(76) Inventor: Goldino Sousa Alves, South Windsor, CT (US)

Correspondence Address: Barry L. Kelmachter, BACHMAN & LaPOINTE, P.C., Suite 1201, 900 Chapel Street, New Haven, CT, 06510-2802, US

(21) Appl. No.: 10/010,203

(22) Filed: Nov. 30, 2001

(51) Int. Cl. F16M 9/00

(52) U.S. Cl. 267/140

(57) ABSTRACT

In accordance with the present invention, an elevator noise and vibration isolation system is provided. The system includes an elevator component, a second component, and at least one vibration isolator being positioned between the elevator component and the second component. Each vibration isolator has a plurality of layers with at least one layer being a hard layer and a second layer being a soft layer. The system may be used to isolate noise and vibration. Components which may have at least one vibration isolator include a slide guide, a roller guide, the cab steadying system, the rope hitch system, and the sheaves.

### BACKGROUND OF THE INVENTION

The present invention relates to an elevator system having one or more periodically layered vibration isolators for reducing noise and isolating vibrations.

Vibration isolation using elastomeric/rubber isolators in elevator applications is important to ensure that the passenger is not exposed to unacceptable noise and vibration levels. Current elevator designs typically utilize single layer elastomeric isolators or metal springs in order to achieve noise and vibration isolation. Most isolator designs are constrained by system level static load and maximum deflection requirements. These constraints require that the isolator exceed a specific stiffness, which significantly reduces their ability to attenuate audible frequencies.

There remains a need for an elevator noise and vibration isolation system which provides improved noise and vibration isolation and better ride quality.

### SUMMARY OF THE INVENTION

Accordingly, it is an object of the present invention to provide an improved elevator noise and vibration isolation system.

It is a further object of the present invention to provide an elevator noise and vibration isolation system as above which is cost effective and improves ride quality.

The foregoing objects are attained by the elevator noise and vibration isolation system of the present invention.

In accordance with the present invention, an elevator noise and vibration isolation system broadly comprises an elevator component, a second component, and at least one vibration isolator being positioned between the elevator component and the second component. Each vibration isolator has a plurality of layers with at least one layer being a hard layer and at least one layer being a soft layer.

Other details of the noise and vibration isolation system of the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 is a schematic representation of a periodically layered vibration isolator;

FIG. 2 is a schematic representation of vibration isolators incorporated into an elevator slide guide system;

FIG. 3 is a schematic representation of a vibration isolator incorporated into a cab steadier system;

FIG. 4 is a schematic representation of an elevator iso-pad system;

FIG. 5 is a schematic representation of the iso-pad system of FIG. 4 with a periodically layered vibration isolator incorporated therein;

FIG. 6 is a top view of an elevator roller guide system;

FIG. 7 is a schematic representation of a portion of the roller guide system of FIG. 6 having periodically layered vibration isolators incorporated therein;

FIG. 8 is a schematic representation of an elevator hitch system;

FIG. 9 is a schematic representation of a periodically layered vibration isolator incorporated into the hitch system of FIG. 8;

FIG. 10 is a schematic representation of a hoist rope system;

FIG. 11 is a schematic representation of a periodically layered vibration isolator being used in connection with a sheave used in the system of FIG. 10; and

FIG. 12 is a schematic representation of a periodically layered vibration isolator being used in connection with a drive sheave used in the system of FIG. 10.

### DETAILED DESCRIPTION OF THE PREFERRED EMBODIMENT(S)

In accordance with the present invention, periodically layered vibration isolators 10 such as that shown in FIG. 1 are used to achieve improved noise and vibration isolation in elevators. Each vibration isolator 10 has at least one hard layer 22 formed from a metallic material or a dense material and at least one soft layer 24 formed from an elastomeric material such as synthetic rubber, natural rubber, and a silicon elastomeric material. Preferably, each vibration isolator 10 has a plurality of alternating hard and soft layers 22 and 24 respectively. The vibration isolator(s) 10 are used to damp vibrations and eliminate noise. Components which use these vibration isolators include slide guides, roller guides, iso-pads, cab steadiers, the rope hitch system, and sheave attachments. A description of these applications is provided below.

As an elevator rises up or down an elevator shaft, its lateral position is maintained by a guidance system. Typically, the guidance system is either a roller guide or a slide guide that rides along vertical guide rails which span the height of an elevator shaft with one rail on either side. These guidance systems are also used to minimize the lateral vibration levels of the elevator. Lateral motion constraints require that the guides be fairly rigid, thus providing little high frequency isolation. By using a periodically layered vibration isolator 10, a required stiffness can be provided while achieving a significant improvement in high frequency isolation.

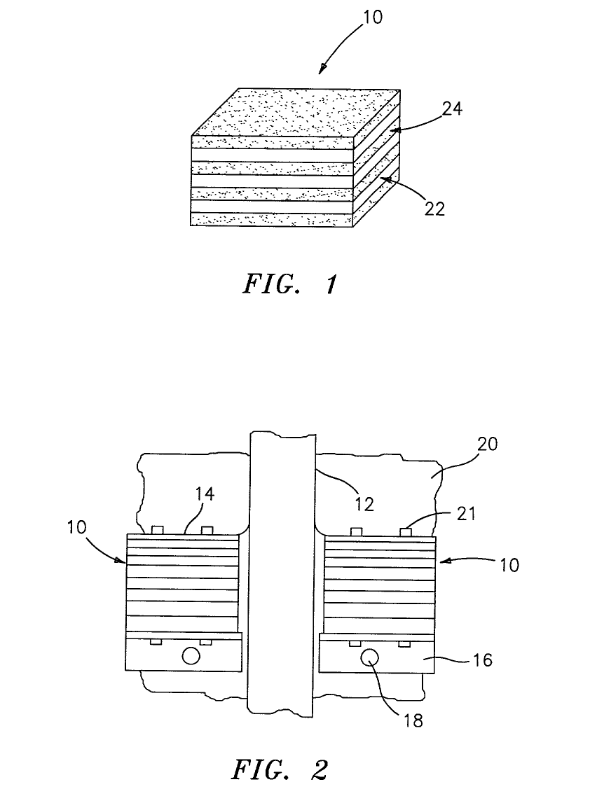

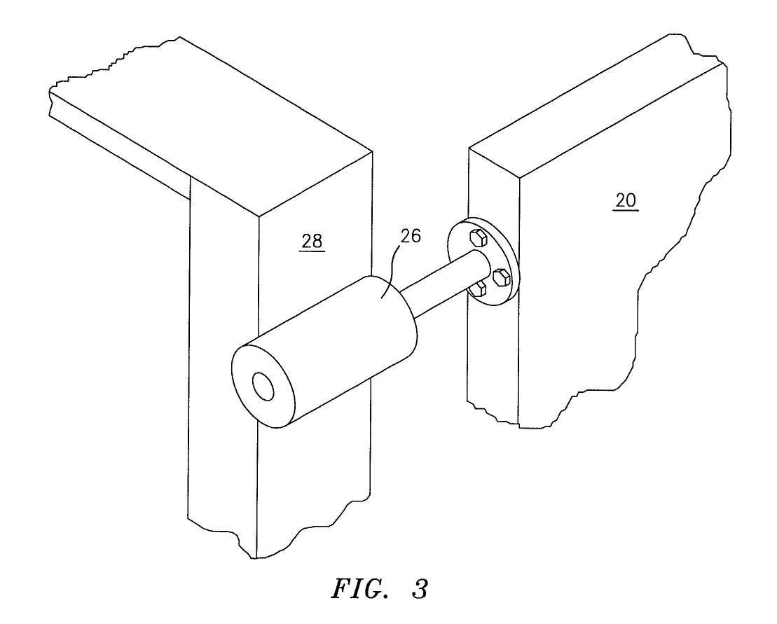

FIG. 2 illustrates a pair of periodically layered vibration isolators 10 of the type shown in FIG. 1 mounted to a guide rail 12 in which a slide guide (not shown) moves. As can be seen from the figure, each vibration isolator 10 is connected to a flange member 14 joined to the guide rail 12 and to a right angle bracket 16 which has an aperture 18 that allows the right angle bracket to be connected to an elevator cab 20. Each vibration isolator 10 may be connected to a respective flange member 14 and to a respective bracket 16 by one or more bolts 21. While it is preferred to use a pair of isolators 10, a single periodically layered vibration isolator may be used.

The vibration isolator system shown in FIG. 1 has been tested and has resulted in a 10 dB reduction in cab noise.

Conventional cab steadiers utilize a combination of metal springs and elastomer (rubber) pads to provide noise and vibration isolation. An improved cab steadier system is shown in FIG. 3. In this system, a roller 26 is mounted to the elevator cab 20 using any suitable means known in the art. The roller 26 moves along a portion of a frame 28 which surrounds the elevator cab 20. In accordance with the present invention, the roller 26 is formed by a cylindrically configured periodically layered vibration isolator having a plurality of alternating hard layers and soft layers.

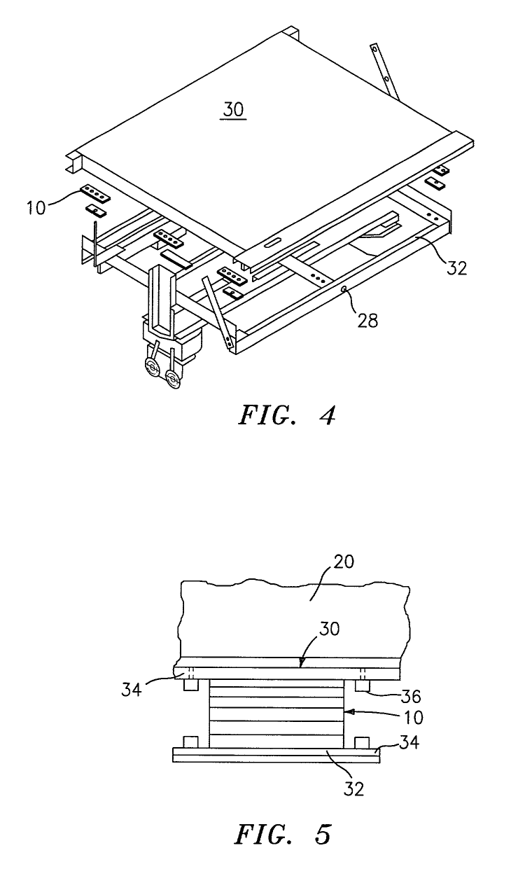

Referring now to FIGS. 4 and 5, most elevators are comprised of the cab 20 and a frame 28 with the floor portion 30 of the cab 20 being mounted on a lower portion 32 of the frame 28 via a set of rubber pads known as iso-pads. These iso-pads isolate the cab 20 from the frame vibrations in both the vertical and lateral directions. In order to support the load of the cab 20 and passenger weight, the iso-pads must be fairly rigid, which reduces its ability to isolate frame vibrations. In accordance with the present invention, the iso-pads are replaced by periodically layered vibration isolators 10 having the same combination of hard and soft layers as shown in FIG. 1. The periodically layered vibration isolator 10 provides the necessary static stiffness and achieves significantly improved vibration isolation. The vibration isolators 10 may be installed between the floor portion 30 and the frame lower portion 32 as shown in FIG. 4 and connected to each by a metal or non-metallic plate 34 attached to each end of the isolator 10 and bolts 36.

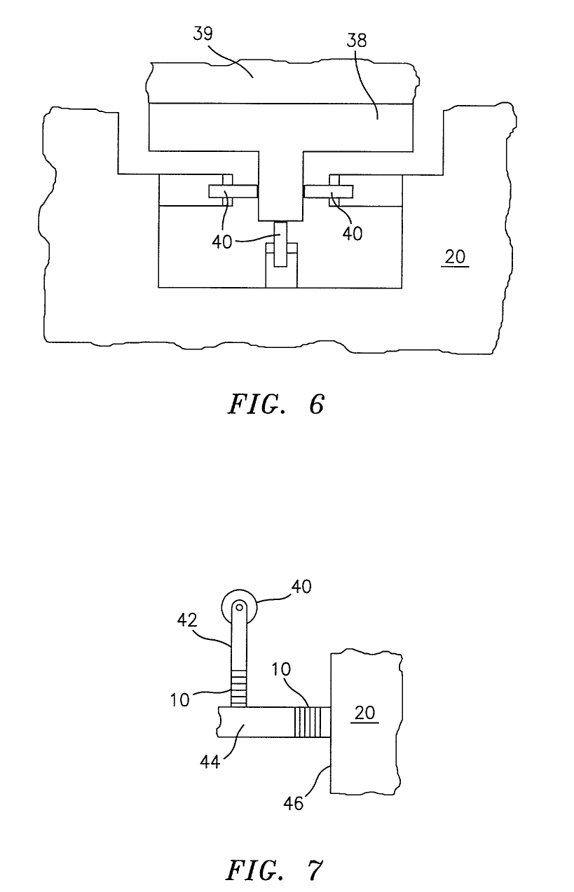

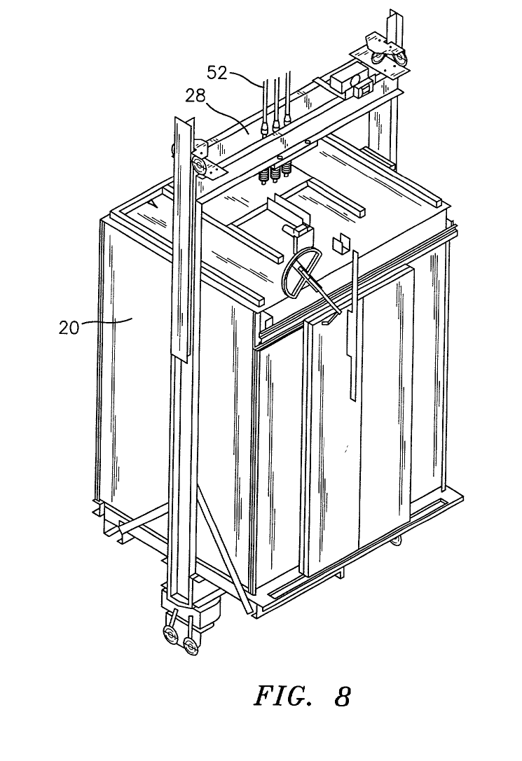

Roller guides are typically rubber isolators often used for two purposes. The first is to minimize the lateral motion between the cab 20 and the frame. The second, in some cases, is to provide structural stiffness to the cab 20 and the frame. Noise reduction and vibration isolation can be improved by incorporating periodically layered vibration isolators 10 of the type shown in FIG. 1 in the roller guides. Referring now to FIGS. 6 and 7, a roller guide system typically involves a T-shaped track 38 mounted to a support structure 39 such as a wall of the elevator shaft. A plurality of rollers 40 contact a plurality of surfaces of the track 38. Each roller 40 is mounted to a portion of the cab 20 by a bracket 42. In one embodiment of the present invention, a layered vibration isolator 10 is positioned between one end of the bracket 42 and a connection 44 to the cab 20. Any suitable means known in the art may be used to join each vibration isolator 10 to the bracket 42 and the connection 44. If desired, a vibration isolator 10 could also be located between the connection 44 and a wall 46 of the cab 20.

Standard car top hitch attachments typically use springs to minimize the transmitted noise and vibration from the ropes to the elevator cab. The design tradeoff is that a soft isolator (spring) maximizes the isolation, but if the spring is too soft accurate vertical positioning of the cab can be difficult. By incorporating a periodically layered vibration isolator 10 into the rope hitch system improved hitch isolation can be achieved by easing this design tradeoff constraint.

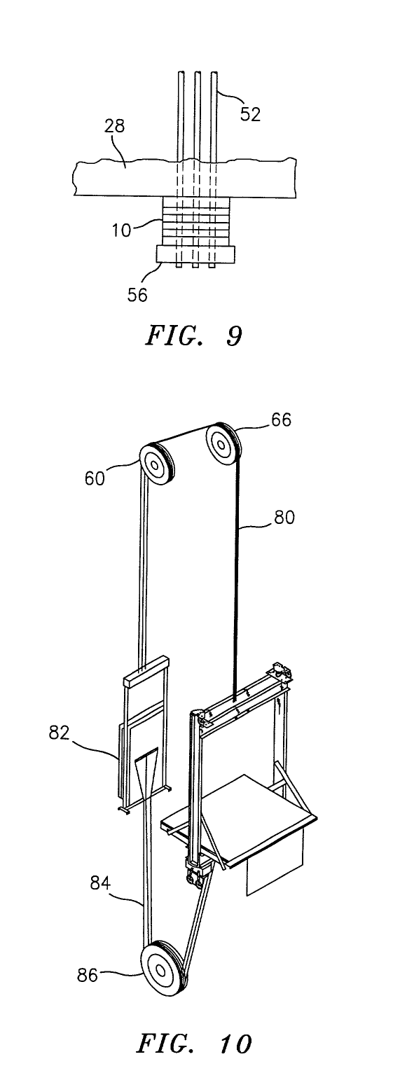

Referring now to FIGS. 8 and 9, a portion of a rope hitch system 50 is illustrated wherein one or more ropes 52 are attached to a portion of the frame 28 surrounding the cab 20. Instead of the normal connection however, a periodically layered vibration isolator 10 of the type shown in FIG. 1 is connected to a lower portion of the frame 28 and to a hitch plate 56 to which the rope(s) 52 are attached. The hitch plate 56 may optionally be attached to the cab 20. The isolator 10 may be joined to the plate 56 and the frame 28 using any suitable means known in the art.

Referring now to FIG. 10, a rope sheave system 59 is illustrated. The system 59 includes a hoist rope 80 attached to the frame 28 and to a counterweight 82. The hoist rope 80 passes over a driven sheave 66 and a deflection sheave 60. The system 59 also includes a compensating rope 84 which is attached to the frame 28 and to the counterweight 82 and which passes over a compensating rope sheave 86. Depending on the roping configuration, sheaves can also be attached to the cab or the frame. In the case, where sheaves are attached to the cab, noise and vibrations can be transmitted to the cab 20. Sheave attachments have similar constraints as the hitch attachment, therefore a periodically layered vibration isolator is a good mechanism for improving isolation at the sheave attachment points.

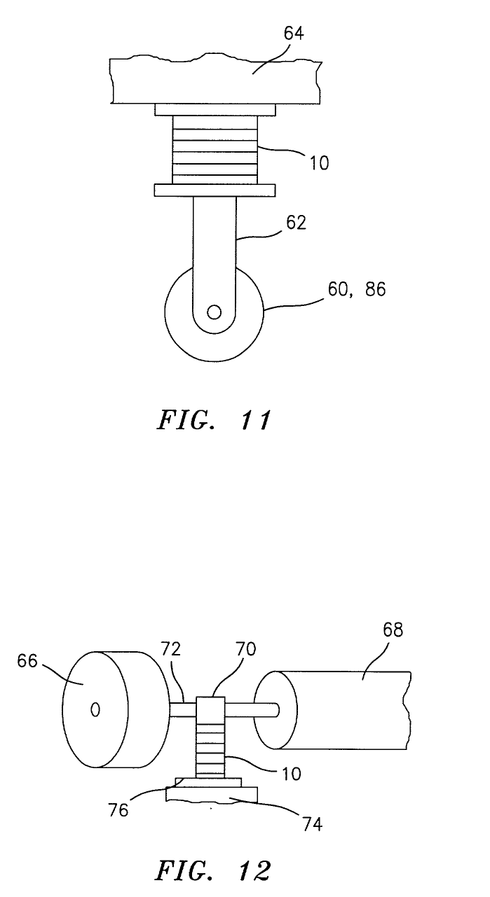

As shown in FIG. 11, sheaves such as deflector sheave 60 and compensating rope sheave 86 have a bracket 62 which is attached to a support structure 64 such as a wall of the elevator shaft. Sheave vibrations can be isolated and noise can be reduced by positioning a periodically layered vibration isolator 10 of the type shown in FIG. 1 between the bracket 62 and the support structure 64 and connecting the isolator 10, via bolts and the like, to the bracket 62 and a plate 65 mounted to the wall.

Drive sheave 66 is driven by a drive unit 68. In such systems, a bearing 70 may be provided around the shaft 72 which connects the sheave 66 and the drive unit 68. A periodically layered vibration isolator 10 of the type shown in FIG. 1 may be attached to the bearing 70 on one side and to a support structure 74, such as a wall, or a plate 76 connected to the wall, on the other side by any suitable means known in the art, such as bolts and the like.

By incorporating periodically layered vibration isolators into elevator systems, one can improve ride quality and achieve financial savings as a result of design changes arising out of the improved noise and vibration isolation. Vibration isolators of the type discussed hereinbefore are termed vibration isolators, but the frequency range these isolators can impact includes the audible range. The physical mechanism responsible for the improved isolation can be considered from either an energy wave or a modal viewpoint. Energy waves are partly reflected at each layer interface due to interference and wave scattering effects resulting from impedance mismatch between layers and internal modes of the isolator. Such a layered component may be considered as a discrete multi-DOF mount having transmission zeros at certain frequencies. Because of these effects, stop band isolation of 20 dB better than a conventional isolator can be achieved. Stop band refers to the frequency band in which the vibration levels are significantly attenuated.

Through proper selection of material properties and geometric considerations, a layered isolator 10 such as those discussed herein can efficiently be tuned to attenuate a desired frequency range. The term “tuned” refers to designing the layers of the isolator 10 so that the stop-band frequency improves overall system performance. The stop-band effect can be designed to occur in the isolator's compression direction, shear direction, or a combination of the two. If necessary, the stop-band frequencies in the shear and compression direction can be designed to be different frequencies.

It is apparent that there has been provided in accordance with the present invention an elevator noise and vibration isolation system which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. An elevator noise and vibration isolation system comprising: an elevator component; a second component; at least one vibration isolator being positioned between said elevator component and said second component; and each said vibration isolator having a plurality of layers with at least one layer being a hard layer and at least one layer being a soft layer.

2. An elevator noise and vibration isolation system according to claim 1, wherein said elevator component comprises an elevator cab, said second component comprises a slide guide rail, and at least one layered vibration isolators being connected to said guide rail and to said elevator cab.

3. An elevator noise and vibration isolation system according to claim 1, wherein said elevator component comprises an elevator cab, said second component comprises a frame, and said at least one vibration isolator is incorporated into a cab steadier which is connected to said cab and contacts and moves along said frame.

4. An elevator noise and vibration isolation system according to claim 1, wherein said elevator component comprises an elevator cab, said second component comprises an elevator frame, and said at least one vibration isolator is positioned between and connected to said cab and said frame.

5. An elevator noise and vibration isolation system according to claim 1, wherein said elevator component comprises an elevator cab, said second component comprises a cab steadying system having a plurality of roller guide elements and said at least one vibration isolator comprising a plurality of layered vibration isolators with each said vibration isolator being positioned between a support for a respective roller guide element and a connection to the elevator cab.

6. An elevator noise and vibration isolation system according to claim 5, further comprising an additional layered vibration isolator between said connection and said elevator cab.

7. An elevator noise and vibration isolation system according to claim 1, wherein said elevator system component comprises a frame, said second component comprises a hitch plate to which at least one rope is connected, and a layered vibration isolator positioned between and connected to said frame and said hitch plate.

8. An elevator noise and vibration system according to claim 1, wherein said elevator component comprises a sheave, said second component comprises a support structure, and said at least one layered vibration isolator is positioned between said support structure and a mounting bracket for said sheave.

9. An elevator noise and vibration system according to claim 1, wherein said elevator component comprises a powered sheave having a driven rotating shaft, said second component comprises a support structure, and said at least one layered vibration isolator is positioned between a bearing surrounding said shaft and said support structure.

10. An elevator noise and vibration system according to claim 1, wherein each said vibration isolator has a plurality of hard layers and a plurality of soft layers and said hard layers and said soft layers are alternating.

11. An elevator noise and vibration system according to claim 10, wherein each said hard layer is formed from at least one material selected from the group consisting of a metallic material and a dense material and each said soft layer is formed from at least one material selected from the group consisting of synthetic rubber, natural rubber, and a silicon elastomeric material.
